(19) United States
(12) Patent Application Publication
(10) Pub. No.: US 2022/0017743 A1
(43) Pub. Date: Jan. 20, 2022

(54) PHOTO-CURABLE COMPOSITIONS FOR ADDITIVE MANUFACTURING

(71) Applicant: Henkel AG & Co. KGaA, Duesseldorf (DE)

(72) Inventors: Chunfu Chen, Kanagawa (JP); Masao Kanari, Kanagawa (JP); Leo Li, Shanghai (CN); Daoqiang Lu, Shanghai (CN)

(21) Appl. No.: 17/487,976

(22) Filed: Sep. 28, 2021

Related U.S. Application Data
(63) Continuation of application No. PCT/CN2019/080000, filed on Mar. 28, 2019.

(51) Int. Cl. C08L 63/00; B33Y 70/10; C08K 3/36; B33Y 10/00; B33Y 80/00; B29C 64/264

(52) U.S. Cl. CPC C08L 63/00; B33Y 70/10; C08K 3/36; B33Y 10/00; B29K 2063/00; B29C 64/264; C08K 2201/011; C08K 2201/005; C08L 2207/53; B33Y 80/00

(57) ABSTRACT

The present invention is directed to a photo-curable composition for use in additive manufacturing, said composition comprising, based on the total weight of the composition:
from 10 to 80 wt. % of a) a dispersion of nanosilica particles in epoxy resin, said nanosilica particles having an average particle size (d50) of less than 50 nm, as measured by dynamic light scattering;
from 10 to 80 wt. % of b) a toughened epoxy resin comprising
   i) core shell rubber particles; and,
   ii) at least one cycloaliphatic epoxy resin; and,
from 0.1 to 10 wt. % of c) a photoinitatior, said photoinitator comprising an ionic photoacid generator.

### FIELD OF THE INVENTION

The present invention concerns materials for the fabrication of solid three-dimensional objects. More particularly, the present invention is concerned with photo-curable compositions which may be used in additive manufacturing processes to join or form solid, three-dimensional (3D) objects.

### BACKGROUND OF THE INVENTION

In conventional additive manufacturing techniques, the construction of a three-dimensional object is performed in a step-wise or layer-by-layer manner. Commonly—and as described in inter alia U.S. Pat. No. 5,236,637 (Hull)—a given layer of photo-curable resin is laid down on either the top surface or the bottom surface of a growing object and then solidified under the action of either visible, infrared or UV light irradiation or under an electron beam.

The photocurable resin used to form the or each layer of the object will contain monomers, oligomers, fillers and additives such as photoinitiators, blockers and colorants depending on the targeted properties of the resin. And photo-curable compositions based on epoxide compounds are known in the art and are of recognized interest in additive manufacturing because epoxy resins can exhibit low curing shrinkage and can obviate problems associated with oxygen inhibition.

WO2017/044381 (Carbon 3D Inc.) describes an epoxy dual cure resin useful for additive manufacturing of three-dimensional objects, which composition includes: (i) a photoinitiator; (ii) monomers and/or prepolymers that are polymerizable by exposure to actinic radiation or light; (iii) optionally, a light absorbing pigment or dye; (iv) an epoxy resin; (v) optionally an organic hardener co-polymerizable with the epoxy resin; (vi) optionally a dual reactive compound having substituted thereon a first reactive group reactive with said monomers and/or prepolymers that are polymerizable by exposure to actinic radiation or light, and a second reactive group reactive with said epoxy resin (e.g., an epoxy acrylate); (vii) optionally a diluent; (viii) optionally a filler; and, (ix) optionally, a co-monomer and/or a co-prepolymer.

JP-A-2002-256062 (Teijin Seiki Co. Ltd) provides an active-energy ray curing resin composition composed of: cationically polymerizable organic compound of which at least a part is constituted by a diepoxy compound (a); a radical-polymerizing organic compound (b); an active-energy ray sensitive cation polymerizing initiator (c); and, an active-energy ray sensitive radical polymerizing initiator (d).

JP-A-2017-007116 (Kao Corporation) provides a photocurable composition for three-dimensional molding containing: A) a photocurable resin precursor; and, B) a fine cellulose fiber and/or a modified article thereof having a number average fiber diameter of 0.5 nm to 200 nm and carboxyl group content of 0.1 mmol/g or more.

One recognized challenge with photo-curable compositions is ensuring that curing proceeds to the appropriate degree at both the surface and the interior of the 3D object or each layer thereof. For example, if the 3D object is cured completely (100%) during the 3D printing process, the interlayer adhesion can be too weak and the print may fail. In addition, the fully cured material may stick to parts of the printing apparatus and not release properly there from. Hence, it is often desirable to cure only in the range of from 5% to 99% and not to 100% during the printing process.

Subsequent to the printing process, uncured resin needs to be removed from the surface of the printing apparatus and the remaining resin cured at an accelerated rate. The uncured liquid resin disposed on the surface of the printed 3D object can often be removed by washing with an appropriate solvent. However, uncured liquid resin within the printed 3D object cannot be so removed and yet is undesirable for a number of reasons: uncured liquid resin containing reactive compounds can leak from the printed 3D object and may be of health concern; uncured liquid resin containing reactive compounds is also problematic in applications of the 3D object where chemical inertness is paramount; and, such uncured liquid resin can deleteriously impact the mechanical performance of the 3D object, principally through softening of the 3D object.

The effective control of curing of photo-curable resins—necessary to prevent the aforementioned problems—becomes more complex where fillers and toughening agents have been included in the compositions in order to achieve certain mechanical properties in the 3D objects obtained by additive manufacturing. Problematically, such adjunct materials will influence the opacity of each layer of composition laid down in the printing process and thereby impact photo-curability and cure depth.

There is considered to be a need in the art to develop novel formulations containing fillers which can be utilized in additive manufacturing processes and which maintain a transparency and a curing profile—in a particular dual curing profile—which can ameliorate or remove the above mentioned problems.

### STATEMENT OF THE INVENTION

In accordance with a first aspect of the present invention there is provided a photo-curable composition for use in additive manufacturing, said composition comprising, based on the total weight of the composition:

from 10 to 80 wt. % of a) a dispersion of nanosilica particles in epoxy resin, said nanosilica particles having an average particle size (d50) of less than 50 nm, as measured by dynamic light scattering;

from 10 to 80 wt. % of b) a toughened epoxy resin comprising
i) core shell rubber particles; and,
ii) at least one cycloaliphatic epoxy resin; and,

from 0.1 to 10 wt. % of c) a photoinitatior, said photoinitator comprising an ionic photoacid generator.

The composition as defined herein above and in the appended claims exhibits good surface light curability when disposed as layer or coating upon a substrate. Subsequent to the irradiation necessary to initiate its curing, the composition can be fully cured either under ambient conditions or by heating, dependent upon the selection of the epoxide compounds (a), b)) and any further curatives present. The cured compositions remain optically clear and show operable mechanical properties which enable their use in deriving complex three dimensional objects by additive manufacturing.

The nanosilica particles of part a) should preferably have an average particle size of from 1 to 40 nm, more preferably from 2 to 30 nm, as measured by dynamic light scattering. It is equally preferred that said nanosilica particles constitute from 10 to 50 wt. % of part a), based on the total weight of said dispersion. And a particular preference for said dispersion of part a) being a colloidal silica sol should be noted.

The epoxy resin of part a) is preferably comprised of at least one diepoxide compound having an epoxy equivalent weights of less than 500. In certain preferred embodiments said epoxy resin of part a) is comprised of at least one polyepoxide compound selected from the group consisting of: glycidyl ethers of polyhydric alcohols; gycidyl ethers of polyhydric phenols; and, glycidyl esters of polycarboxylic acids.

Said core shell rubber particles of part b) should preferably have an average particle size (d50) of from 10 nm to 300 nm, more preferably from 50 nm to 200 nm, as measured via dynamic light scattering. Independently of, or supplementary to this condition, said core shell rubber particles preferably constitute from 10 to 50 wt. % of part b), based on the total weight of said dispersion.

Part b) of the composition may preferably be characterized in that said at least one cycloaliphatic epoxy resin of part b) is selected from the group consisting of: cyclohexanedimethanol diglycidyl ether; bis(3,4-epoxycyclohexylmethyl) adipate; bis(3 4-epoxy-6-m ethylcyclohexylmethyl) adipate; bis(2,3-epoxycyclopentyl) ether; 3,4-epoxycyclohexylmethyl; 3,4-epoxycyclohexanecarboxylate; 1,4-cyclohexanedimethanol diglycidyl ether; diglycidyl 1,2-cyclohexanedicarboxylate; and, cycloaliphatic epoxy resins obtained by the hydrogenation of aromatic bisphenol A diglycidyl ether (BADGE) epoxy resins.

Whilst the photoinitiator c) need not be so characterized, it is preferred that it either consists essentially of or consists of said photoacid generator. For example, an effective example of the present invention is provided wherein the photoinitiator c) consists of an ionic photoacid generator which is a salt selected from the group consisting of: hexafluoroantimonate salts; hexafluoroarsenate salts; hexafluorophosphate salts; and tetrafluoroborate salts.

In accordance with a second aspect of the present invention, there is provided a method for forming a three dimensional object, said method comprising:

i) providing a carrier and an optically transparent member having a movable build surface, said carrier and build surface defining a build region there between;

ii) within said build region, applying by 3D printing a first layer of the composition as defined herein above and in the appended claims;

iii) irradiating said build region through said optically transparent member to at least partially cure that first layer;

iv) applying a subsequent layer of said composition as defined herein above and in the appended claims by 3D printing on the at least partially cured layer; and,

v) irradiating said build region through said optically transparent member to at least partially cure that subsequent layer.

In an embodiment thereof, there is provided an iterative method for forming a three dimensional object, wherein said steps iv) and v) as defined above are performed and repeated so as to dispose second, third, fourth and further layers within the build region.

It will be recognized that the recited build surface may be moved away from the carrier to maintain a suitable build region for the application of the defined composition. The build surface and the formed layers of at least partially cured composition provide the scaffold on which subsequent layers may be disposed: the provision of further support means is not precluded, however, and can be applied at an appropriate time to maintain the integrity of an intermediate and/or final three dimensional object. That final object may be separated from all supporting media and further processed, if necessary.

In accordance with a third aspect of the invention there is provided a three dimensional object obtained in accordance with the method defined herein above and in the appended claims.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps.

As used herein, the term “consisting of” excludes any element, ingredient, member or method step not specified.

As used herein, the term “consisting essentially of” limits the scope of a claim to the specified element, ingredient, member or method step and those supplementary elements, ingredients, members or methods steps which do not materially affect the basic and novel characteristic(s) of the claimed invention.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

The term “additive manufacturing” as used herein refers to methods of joining or shaping materials by which objects are built from 3D-model data, usually layer-upon-layer; it may be contrasted with subtractive manufacturing technologies. The term “3D-printing” is often used as a synonym for additive manufacturing. Conventionally, a digital model of the object is generated using known modeling methods, including Computer Aided Design (CAD) programs: the digital model is divided into units in which each unit indicates where the material should be located in a layer. The individual units are sent to an additive manufacturing system or 3D printer which deposits the material according to the individual units and generates the complete three-dimensional object layer by layer. The disclosure of ASTM52900-15 or, where appropriate, the updated version of said Standard may here be instructive.

As used herein, the term “(co)polymer” includes homopolymers, copolymers, block copolymers and terpolymers.

As used herein, the term “epoxide” denotes a compound characterized by the presence of at least one cyclic ether group, namely one wherein an ether oxygen atom is attached to two adjacent carbon atoms thereby forming a cyclic structure. The term is intended to encompass monoepoxide compounds, polyepoxide compounds (having two or more epoxide groups) and epoxide terminated prepolymers. The term “monoepoxide compound” is meant to denote epoxide compounds having one epoxy group. The term “polyepoxide compound” is meant to denote epoxide compounds having at least two epoxy groups. The term “diepoxide compound” is meant to denote epoxide compounds having two epoxy groups.

The epoxide may be unsubstituted but may also be inertly substituted. Exemplary inert substituents include chlorine, bromine, fluorine and phenyl.

As used herein, “epoxy equivalent weight” means that weight of resin, in grams, that contains one equivalent of epoxy. The number of epoxide groups in the epoxide compound is determined by heating a weighted sample of the compound with an excess of 0.2 N pyridinium chloride in chloroform solution at the boiling point under reflux for two hours whereby the pyridinium chloride hydrochlorinates the epoxy groups to the chlorohydrin groups. After cooling, the excess pyridinium chloride is back-titrated with 0.1 N sodium hydroxide in methanol to the phenolphthalein and point. Reference is made to: ASTM D1652-11 Standard Test Method for Epoxy Content of Epoxy Resins.

As used herein, the term “toughened epoxy resin” refers in its broadest sense to an epoxy resin which has undergone toughening modification or treatment by a toughening agent based on either a physical or chemical mechanism. The toughening agent may be physically pre-dispersed in the epoxy resin matrix. The toughening agent may be reactive and capable of reacting substantially completely to form chemical bonds to the epoxy resin matrix.

The term “aliphatic” as used herein means a straight or branched, saturated or unsaturated hydrocarbon group. Aliphatic includes alkyl groups, alkenyl groups, and alkynyl groups.

The term “cycloaliphatic” as used herein refers to a linear or branched, saturated or unsaturated hydrocarbon group, which contains at least one cycloalkyl group, and wherein one or more methylene groups of the hydrocarbon group are optionally replaced with a heteroatom selected from oxygen, nitrogen and sulfur and/or a carbonyl group. The cycloaliphatic group does not contain any aromatic moieties. The cycloalkyl group may form part of the main chain of the hydrocarbon group, or may be a substituent of the main chain at any substitutable position. Such groups are optionally substituted by halogen atoms at any substitutable position.

The term “alicyclic” as used herein refers to compounds which combine the properties of aliphatic and cyclic compounds and include, but are not limited, to monocyclic or polycyclic aliphatic hydrocarbons and bridged cycloalkyl compounds, which are optionally substituted with one or more functional groups. As will be appreciated by the skilled reader, “alicyclic” is intended herein to include, but not to be limited to, cycloalkyl, cycloalkenyl, and cycloalkynyl moieties, which are optionally substituted with one or more functional groups. Illustrative alicyclic groups, which may optionally bear one or more substitutents, include: cyclopropyl; —CH₂-cyclopropyl; cyclobutyl; —CH₂-cyclobutyl, cyclopentyl; —CH₂-cyclopentyl; cyclohexyl; —CH₂-cyclohexyl; cyclohexenylethyl; cyclohexanylethyl; and, norbornyl.

As used herein, “C₁-Cₙ alkyl” group refers to a monovalent group that contains 1 to n carbons atoms, that is a radical of an alkane and includes straight-chain and branched organic groups. As such, a “C₁-C₃₀ alkyl” group refers to a monovalent group that contains from 1 to 30 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more substituents such as halo, nitro, cyano, amido, amino, sulfonyl, sulfinyl, sulfanyl, sulfoxy, urea, thiourea, sulfamoyl, sulfamide and hydroxy. The halogenated derivatives of the exemplary hydrocarbon radicals listed above might, in particular, be mentioned as examples of suitable substituted alkyl groups. In general, however, a preference for unsubstituted alkyl groups containing from 1-18 carbon atoms (C₁-C₁₈ alkyl)—for example unsubstituted alkyl groups containing from 1 to 12 carbon atoms (C₁-C₁₂ alkyl)—should be noted.

The term “C₃-C₃₀ cycloalkyl” is understood to mean a saturated, mono-, bi- or tricyclic hydrocarbon group having from 3 to 30 carbon atoms. In general, a preference for cycloalkyl groups containing from 3-18 carbon atoms (C₃-C₁₈ cycloalkyl groups) should be noted. Examples of cycloalkyl groups include: cyclopropyl; cyclobutyl; cyclopentyl; cyclohexyl; cycloheptyl; cyclooctyl; adamantane; and, norbornane.

As used herein, an “C₆-C₁₈ aryl” group used alone or as part of a larger moiety—as in “aralkyl group”—refers to optionally substituted, monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. Exemplary aryl groups include: phenyl; indenyl; naphthalenyl, tetrahydronaphthyl, tetrahydroindenyl; tetrahydroanthracenyl; and, anthracenyl. And a preference for phenyl groups may be noted.

As used herein, “C₂-C₁₂ alkenyl” refers to hydrocarbyl groups having from 2 to 12 carbon atoms and at least one unit of ethylenic unsaturation. The alkenyl group can be straight chained, branched or cyclic and may optionally be substituted. The term “alkenyl” also encompasses radicals having “cis” and “trans” configurations, or alternatively, “E” and “Z” configurations, as appreciated by those of ordinary skill in the art. In general, however, a preference for unsubstituted alkenyl groups containing from 2 to 10 (C₂-10) or 2 to 8 (C₂-8) carbon atoms should be noted. Examples of said C₂-C₁₂ alkenyl groups include, but are not limited to: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)═CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “alkylaryl” refers to alkyl-substituted aryl groups and “substituted alkylaryl” refers to alkylaryl groups further bearing one or more substituents as set forth above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl” and “heterocycloalkyl” moieties are alkyl and cycloalkyl groups as defined hereinabove, respectively, containing N, O, Si or S as part of their structure.

As used herein, the term “catalytic amount” means a sub-stoichiometric amount of catalyst relative to a reactant, except where expressly stated otherwise.

The term “photo-curable composition” as used herein refers to a composition including a component which can be cross-linked, polymerized or cured by electromagnetic wave irradiation. The term “electromagnetic wave” is a generic term including microwaves, infrared radiation, UV light, visible light, X-rays, y-rays and particles beams including α-particles, proton beams, neutron beams and electron beams.

The term “photoinitiator” as used herein denotes a compound which can be activated by an energy-carrying activation beam—such as electromagnetic radiation—for instance upon irradiation therewith. The term is intended to encompass both photoacid generators and photobase generators. Specifically, the term “photoacid generator” refers to a compound or polymer which generates an acid for the catalysis of the acid hardening resin system upon exposure to actinic radiation. The term “photobase generator” means any material which when exposed to suitable radiation generates one or more bases.

The term “Lewis acid” used herein denotes any molecule or ion—often referred to as an electrophile—capable of combining with another molecule or ion by forming a covalent bond with two electrons from the second molecule or ion: a Lewis acid is thus an electron acceptor.

As employed herein a “primary amino group” refers to an NH₂ group that is attached to an organic radical, and a “secondary amino group” refers to an NH group that is attached to two organic radicals, which may also together be part of a ring. Where used, the term “amine hydrogen” refers to the hydrogen atoms of primary and secondary amino groups.

The “amine equivalent weight” is a calculated value determined from the amine number. That amine number is determined by titration of the amine acetate ion by a dilute, typically 1N HCl solution. For a pure material, the amine number can be calculated using the molecular weights of the pure compound and KOH (56.1 g/mol). Instructive guidance may be found, for illustration, in https://dowac.custhelp.com/app/answers/detail/a_id/12987.

The term “Mannich Base” is used herein in accordance with its standard definition in the art as a ketonic amine obtainable from the condensation of a ketone with formaldehyde and ammonia or a primary or secondary amine (https://pubchem.ncbi.nlm.nih.gov/compound/9567537#section=Top).

“Two-component (2K) compositions” in the context of the present invention are understood to be compositions in which an epoxide-group containing component and the hardener (curative) component must be stored in separate vessels because of their (high) reactivity. The two components are mixed only shortly before application and then react—where necessary under additional activation—with bond formation and thereby formation of a polymeric network. However, catalysts may also be employed or higher temperatures applied in order to accelerate the cross-linking reaction.

As used herein the qualification “rigid” defines a component that is self-supporting, inflexible and non-compressible.

Having regard to “supporting media” mentioned above, that media should be rigid and thus should be self-supporting and provide mechanical support to the coating layer disposed thereon. Without intention to the limit the present invention, that rigid supporting media should preferably be characterized by at least one of: a tensile modulus of at least 2000 MPa, as measured in accordance with ASTM D 638 at a temperature of 23° C.±2° C.; and a Flexural Modulus of at least 2000 MPa, as measured in accordance with ASTM D 790 at a temperature of 23° C.±2° C.

The Shore A hardness of a given material mentioned herein is determined using a durometer in accordance with ISO 868 entitled “Plastics and Ebonite—Determination of Indentation Hardness by Means of a Durometer (Shore Hardness)”, the contents of which standard are incorporated herein by reference in their entirety. Throughout the present description, all standard Shore A hardness measurements were performed on injection molded plates at 10 seconds using Type A durometer.

Viscosities of the compositions described herein are, unless otherwise stipulated, measured using the Brookfield Viscometer, Model RVT at standard conditions of 20° C. and 50% Relative Humidity (RH). The viscometer is calibrated using silicone oils of known viscosities, which vary from 5,000 cps to 50,000 cps. A set of RV spindles that attach to the viscometer are used for the calibration. Measurements of the compositions are done using the No. 6 spindle at a speed of 20 revolutions per minute for 1 minute until the viscometer equilibrates. The viscosity corresponding to the equilibrium reading is then calculated using the calibration.

The molecular weights referred to in this specification can be measured with gel permeation chromatography (GPC) using polystyrene calibration standards, such as is done according to ASTM 3536.

As used herein, “ambient conditions” means the temperature and pressure of the surroundings in which the coating layer or the substrate of said coating layer is located.

As used herein, “anhydrous” means the relevant composition includes less than 0.25% by weight of water. For example, the composition may contain less than 0.1% by weight of water or be completely free of water. The term “essentially free of solvent” should be interpreted analogously as meaning the relevant composition comprises less than 0.25% by weight of solvent.

### DETAILED DESCRIPTION OF THE INVENTION

Part a): Epoxide Compounds Pre-Mixed with Inorganic Filler

The present composition is defined as comprising from 10 to 80 wt. %, preferably from 25 to 65 wt. %, of a) a dispersion of nanosilica particles in epoxy resin, said nanosilica particles having an average particle size (d50) of less than 50 nm, as measured by dynamic light scattering.

There is no particular intention to limit the epoxy resins which may be used in this part of the composition. As such, epoxy resins as used herein may include mono-functional epoxy resins, multi- or poly-functional epoxy resins, and combinations thereof. The epoxy resins may be pure compounds but equally may be mixtures epoxy functional compounds, including mixtures of compounds having different numbers of epoxy groups per molecule. An epoxy resin may be saturated or unsaturated, aliphatic, cycloaliphatic, aromatic or heterocyclic and may be substituted. Further, the epoxy resin may also be monomeric or polymeric.

Without intention to limit the processes of present invention, illustrative monoepoxide compounds include: alkylene oxides; epoxy-substituted cycloaliphatic hydrocarbons, such as cyclohexene oxide, vinylcyclohexene monoxide, (+)-cis-limonene oxide, (+)-cis,trans-limonene oxide, (−)-cis,trans-limonene oxide, cyclooctene oxide, cyclododecene oxide and α-pinene oxide; epoxy-substituted aromatic hydrocarbons; monoepoxy substituted alkyl ethers of monohydric alcohols or phenols, such as the glycidyl ethers of aliphatic, cycloaliphatic and aromatic alcohols; monoepoxy-substituted alkyl esters of monocarboxylic acids, such as glycidyl esters of aliphatic, cycloaliphatic and aromatic monocarboxylic acids; monoepoxy-substituted alkyl esters of polycarboxylic acids wherein the other carboxy group(s) are esterified with alkanols; alkyl and alkenyl esters of epoxy-substituted monocarboxylic acids; epoxyalkyl ethers of polyhydric alcohols wherein the other OH group(s) are esterified or etherified with carboxylic acids or alcohols; and, monoesters of polyhydric alcohols and epoxy monocarboxylic acids, wherein the other OH group(s) are esterified or etherified with carboxylic acids or alcohols.

By way of example, the following glycidyl ethers might be mentioned as being particularly suitable monoepoxide compounds for use herein: methyl glycidyl ether; ethyl glycidyl ether; propyl glycidyl ether; butyl glycidyl ether; pentyl glycidyl ether; hexyl glycidyl ether; cyclohexyl glycidyl ether; octyl glycidyl ether; 2-ethylhexyl glycidyl ether; allyl glycidyl ether; benzyl glycidyl ether; phenyl glycidyl ether; 4-tert-butylphenyl glycidyl ether; 1-naphthyl glycidyl ether; 2-naphthyl glycidyl ether; 2-chlorophenyl glycidyl ether; 4-chlorophenyl glycidyl ether; 4-bromophenyl glycidyl ether; 2,4,6-trichlorophenyl glycidyl ether; 2,4,6-tribromophenyl glycidyl ether; pentafluorophenyl glycidyl ether; o-cresyl glycidyl ether; m-cresyl glycidyl ether; and, p-cresyl glycidyl ether.

In an embodiment, the monoepoxide compound conforms to Formula (III) herein below:

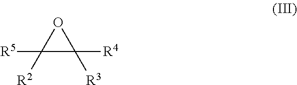

wherein: R², R³, R⁴ and R⁵ may be the same or different and are independently selected from hydrogen, a halogen atom, a C₁-C₈ alkyl group, a C₃ to C₁₀ cycloalkyl group, a C₂-C₁₂ alkenyl, a C₆-C₁₈ aryl group or a C₇-C₁₈ aralkyl group, with the proviso that at least one of R³ and R⁴ is not hydrogen.

It is preferred that R², R³ and R⁵ are hydrogen and R⁴ is either a phenyl group or a C₁-C₈ alkyl group and, more preferably, a C₁-C₄ alkyl group.

Having regard to this embodiment, exemplary monoepoxides include: ethylene oxide; 1,2-propylene oxide (propylene oxide); 1,2-butylene oxide; cis-2,3-epoxybutane; trans-2,3-epoxybutane; 1,2-epoxypentane; 1,2-epoxyhexane; 1,2-heptylene oxide; decene oxide; butadiene oxide; isoprene oxide; and, styrene oxide.

In the present invention, recognition is given to using at least one monoepoxide compound selected from the group consisting of: ethylene oxide; propylene oxide; cyclohexene oxide; (+)-cis-limonene oxide; (+)-cis,trans-limonene oxide; (−)-cis,trans-limonene oxide; cyclooctene oxide; and cyclododecene oxide.

Again, without intention to limit the processes of present invention, suitable polyepoxide compounds may be liquid, solid or in solution in solvent. Further, such polyepoxide compounds should have an epoxy equivalent weight of from 100 to 700 g/eq, for example from 120 to 320 g/eq. And generally, diepoxide compounds having epoxy equivalent weights of less than 500 or even less than 400 are preferred: this is predominantly from a cost standpoint, as in their production, lower molecular weight epoxy resins require more limited processing in purification.

As examples of types or groups of polyepoxide compounds which may be polymerized in present invention, mention may be made of: epoxidized polyethylenically unsaturated hydrocarbons, esters, ethers and amides; glycidyl ethers of polyhydric alcohols and polyhydric phenols; and glycidyl esters of polycarboxylic acids.

The use of epoxidized polyolefin which possesses residual olefinic unsaturation is encompassed by the present invention: mention in this regard may be made of epoxidized polymers of butadiene, isoprene or piperylene and the copolymers of butadiene, isoprene or piperylene with mono-olefins, such as butene, styrene and substituted styrene; nitriles, such as acrylonitrile and methacrylonitrile; or, esters of acrylic and methacrylic acid. More particularly, the epoxidized polyolefin may be an epoxidized polybutadiene, epoxidized polyisoprene, or an epoxidized copolymer of butadiene or isoprene with styrene. Epoxidized butadiene polymers are preferred and U.S. Pat. No. 3,030,336 may be noted as an instructive reference for the preparation of such polymers.

Suitable diglycidyl ether compounds may be aromatic, aliphatic or cycloaliphatic in nature and, as such, can be derivable from dihydric phenols and dihydric alcohols. And useful classes of such diglycidyl ethers are: diglycidyl ethers of aliphatic and cycloaliphatic diols, such as 1,2-ethanediol, 1,4-butanediol, 1,6-hexanediol, 1,8-octanediol, 1,12-dodecanediol, cyclopentane diol and cyclohexane diol; bisphenol A based diglycidylethers; bisphenol F diglycidyl ethers; diglycidyl o-phthalate, diglycidyl isophthalate and diglycidyl terephthalate; polyalkyleneglycol based diglycidyl ethers, in particular polypropyleneglycol diglycidyl ethers; and, polycarbonatediol based glycidyl ethers. Other suitable diepoxides which might also be mentioned include: diepoxides of double unsaturated fatty acid C1-C18 alkyl esters; butadiene diepoxide; polybutadiene diglycidyl ether; vinylcyclohexene diepoxide; and, limonene diepoxide.

Further illustrative polyepoxide compounds include but are not limited to: glycerol polyglycidyl ether; trimethylolpropane polyglycidyl ether; pentaerythritol polyglycidyl ether; diglycerol polyglycidyl ether; polyglycerol polyglycidyl ether; and, sorbitol polyglycidyl ether.

And examples of highly preferred polyepoxide compounds include: bisphenol-A epoxy resins, such as DER™ 331, and DER™ 383; bisphenol-F epoxy resins, such as DER™ 354; bisphenol-NF epoxy resin blends, such as DER™ 353; aliphatic glycidyl ethers, such as DER™ 736; polypropylene glycol diglycidyl ethers, such as DER™ 732; solid bisphenol-A epoxy resins, such as DER™ 661 and DER™ 664 UE; solutions of bisphenol-A solid epoxy resins, such as DER™ 671-X75; epoxy novolac resins, such as DEN™ 438; brominated epoxy resins such as DER™ 542; castor oil triglycidyl ether, such as ERISYS™ GE-35H; polyglycerol-3-polyglycidyl ether, such as ERISYS™ GE-38; and, sorbitol glycidyl ether, such as ERISYS™ GE-60.

Whilst it is does not represent a preferred embodiment, the present invention does not preclude the dispersion of part a) further comprising one or more cyclic compounds selected from the group consisting of: oxetanes; cyclic carbonates; cyclic anhydrides; and lactones. The disclosures of the following citations may be instructive in disclosing suitable cyclic carbonate functional compounds: U.S. Pat. Nos. 3,535,342; 4,835,289; 4,892,954; UK Patent No. GB-A-1,485,925; and EP-A-0 119 840. However, such cyclic compounds should constitute less than 10 wt. %, preferably less than 5 wt. % or less than 2 wt. %, based on the total weight of part (a) of the composition.

This part of the curable composition comprises nanosilica of which the average particle size is less than 50 nm, said particle size referring to the diameter or largest dimension of a particle in a distribution of particles and being measured via dynamic light scattering. The nanosilica particles should desirably have an average particle size of from 1 to 40 nm, for instance from 2 to 30 nm.

The nanosilica particles should typically constitute from 10 to 50 wt. % of part a), based on the total weight of said dispersion. It is preferred that the nanoparticles constitute from 10 to 40 wt. %, for example from 10 to 30 wt. % of part a) based on the weight of said dispersion.

In an alternative expression to define the constituency of the part a) dispersion, which expression is not intended to be mutually exclusive of that mentioned above, the nanosilica may be included in the composition in an amount of from 1 to 10 wt. % based on the total weight of the composition. A preference may be mentioned for the use of nanosilica in an amount of from 2 to 8 wt. %, based on the total weight of the composition.

The nanosilica should advantageously have a BET surface area from 10 to 90 m²/g. When such nanosilica is employed, it does not cause any additional increase in the viscosity of the composition according to the present invention, but does contribute to strengthening the cured composition.

It is likewise conceivable to use nanosilica having a higher BET surface area, advantageously from 100 to 250 m²/g, in particular from 110 to 170 m²/g as at least a part of the total nanosilica present: because of the greater BET surface area, the effect of strengthening the cured composition is achieved with a smaller proportion by weight of silicic acid.

In a number of embodiments, the nanosilica is provided as a colloidal silica sol in the epoxy resin matrix with surface modified, spherically shaped silica nanoparticles which, for the sake of completeness, may meet the particle size and surface area characteristics mentioned above. Such colloidal silica sol is conventionally synthesized from an aqueous sodium silicate solution and then undergoes a process of surface modification with organosilane and matrix exchange to produce a masterbatch of pre-determined weight (or volume) percentage in the epoxy resin.

### Part b): Toughened Cycloaliphatic Epoxy Resin

The present composition is defined as comprising from 10 to 80 wt. %, preferably from 15 to 65 wt. % of b) a toughened epoxy resin comprising: i) a core-shell rubber particles; and ii) at least one cycloaliphatic epoxy resin.

As regards part b) i) above, core-shell rubber particles are pre-dispersed in a liquid epoxy resin matrix. The term “core shell rubber” or CSR is being employed in accordance with its standard meaning in the art as denoting a rubber particle core formed by a polymer comprising an elastomeric or rubbery polymer as a main ingredient and a shell layer formed by a polymer which is graft polymerized onto the core. The shell layer partially or entirely covers the surface of the rubber particle core in the graft polymerization process. By weight, the core should constitute at least 50 wt. % of the core-shell rubber particle.

The polymeric material of the core should have a glass transition temperature (T_{g}) of no greater than 0° C. and preferably a glass transition temperature (T_{g}) of −20° C. or lower, more preferably −40° C. or lower and even more preferably −60° C. or lower.

The polymer of the shell is non-elastomeric, thermoplastic or thermoset polymer having a glass transition temperature (T_{g}) of greater than room temperature, preferably greater than 30° C. and more preferably greater than 50° C.

Without intention to limit the invention, the core may be comprised of: a diene homopolymer, for example, a homopolymer of butadiene or isoprene; a diene copolymer, for example a copolymer of butadiene or isoprene with one or more ethylenically unsaturated monomers, such as vinyl aromatic monomers, (meth)acrylonitrile or (meth)acrylates; polymers based on (meth)acrylic acid ester monomers, such as polybutylacrylate; and, polysiloxane elastomers such as polydimethylsiloxane and crosslinked polydimethylsiloxane.

Similarly, without intention to limit the present invention, the shell may be comprised of a polymer or copolymer of one or more monomers selected from: (meth)acrylates, such as methyl methacrylate; vinyl aromatic monomers, such as styrene; vinyl cyanides, such as acrylonitrile; unsaturated acids and anhydrides, such as acrylic acid; and (meth)acrylamides. The polymer or copolymer used in the shell may possess acid groups that are cross-linked ionically through metal carboxylate formation, in particular through forming salts of divalent metal cations. The shell polymer or copolymer may also be covalently cross-linked by monomers having two or more double bonds per molecule.

It is preferred that the core-shell rubber particles have an average particle size (d50) of from 10 nm to 300 nm, for example from 50 nm to 200 nm: said particle size refers to the diameter or largest dimension of a particle in a distribution of particles and is measured via dynamic light scattering.

The present application does not preclude the presence of two types of core shell rubber (CSR) particles with different particle sizes in the composition to provide a balance of key properties of the resultant cured product, including shear strength, peel strength and resin fracture toughness. In this embodiment, smaller included particles (1^{st} CSR type) may have an average particle size of from 10 to 100 nm and larger included particles (2^{nd} CSR type) may have an average particle size of from 120 nm to 300 nm, for example from 150 to 300 nm. The smaller core shell rubber particles should typically be employed in excess of the larger particles on a weight basis: a weight ratio of smaller CSR particles to larger CSR particles of from 3:1 to 5:1 may be employed for instance.

The core-shell rubber may be selected from commercially available products, examples of which include: Paraloid EXL 2650A, EXL 2655 and EXL2691 A, available from The Dow Chemical Company; the Kane Ace® MX series available from Kaneka Corporation, and in particular MX 120, MX 125, MX 130, MX 136, MX 551, MX553; and METABLEN SX-006 available from Mitsubishi Rayon.

The core shell rubber particles should typically constitute from 10 to 50 wt. % of part b), based on the total weight of said part. It is preferred that the core shell rubber particles constitute from 10 to 40 wt. %, for example from 10 to 30 wt. % of part b) based on the weight of said part.

In an alternative expression to define the constituency of the part b) dispersion, which expression is not intended to be mutually exclusive of that mentioned above, the core shell rubber particles may be included in the composition in an amount of from 1 to 10 wt. % based on the total weight of the composition. A preference may be mentioned for the use of core shell rubber particles in an amount of from 2 to 8 wt. %, based on the total weight of the composition.

As noted above, part b) ii) is constituted by at least one cycloaliphatic epoxy resin. Said cycloaliphatic epoxy comprises at least one epoxy group which may be in the form of: a terminal epoxy group; a glycidyl ether (e.g. —O—CH₂-epoxide); or, an epoxide fused to a C₅₋₇ cycloalkyl group.

Without intention to limit the present invention, suitable cycloaliphatic epoxy resins include: cyclohexanedimethanol diglycidyl ether; bis(3,4-epoxycyclohexylmethyl) adipate; bis(3 4-epoxy-6-methylcyclohexylmethyl) adipate; bis(2,3-epoxycyclopentyl) ether; 3,4-epoxycyclohexylmethyl; 3,4-epoxycyclohexanecarboxylate; 1,4-cyclohexanedimethanol diglycidyl ether; diglycidyl 1,2-cyclohexanedicarboxylate; and cycloaliphatic epoxy resins obtained by the hydrogenation of aromatic bisphenol A diglycidyl ether (BADGE) epoxy resins.

Preferably the cycloaliphatic epoxy comprises two C₅₋₆ cycloalkyl groups wherein each are independently fused to an epoxide such as bis(3,4-epoxycyclohexylmethyl) adipate, bis(3 4-epoxy-6-methylcyclohexylmethyl) adipate, bis(2,3-epoxycyclopentyl) ether, or 3,4-epoxycyclohexylmethyl 3,4-epoxycyclohexanecarboxylate.

### Part c): Photoinitiator

The present composition is defined as comprising from 0.1 to 10 wt. %, preferably from 0.5 to 5 wt. % of c) a photoinitiator, which photoinitiator necessarily comprises an ionic photoacid generator (PAGs). Upon irradiation with light energy, ionic photoacid generators undergo a fragmentation reaction and release one or more molecules of Lewis or Bronsted acid that catalyze the ring opening and addition of the pendent epoxide groups to form a crosslink.

Useful photoacid generators are thermally stable, do not undergo thermally induced reactions with the forming copolymer and are readily dissolved or dispersed in the curable compositions. Photoacid generators are known in the art and instructive reference may be made to: K. Dietliker, Chemistry and Technology of UV and EB Formulation for Coatings, Inks and Paints, Vol. III, SITA Technology Ltd., London (1991); and Kirk-Othmer Encyclopedia of Chemical Technology, 4.Sup.Th Edition, Supplement Volume, John Wiley and Sons, New York, pp 253-255.

Exemplary cations which may be used as the cationic portion of the ionic PAG of the invention include organic onium cations such as those described in U.S. Pat. Nos. 4,250,311, 3,113,708, 4,069,055, 4,216,288, 5,084,586, 5,124,417, and 5,554,664. The references specifically encompass aliphatic or aromatic Group IVA and VIIA (CAS version) centered onium salts, with a preference being noted for I-, S-, P-, Se- N- and C-centered onium salts, such as those selected from sulfoxonium, iodonium, sulfonium, selenonium, pyridinium, carbonium and phosphonium.

As is known in the art, the nature of the counter-anion in the ionic photoacid generator (PAG) can influence the rate and extent of cationic addition polymerization of the epoxy groups. For illustration, Crivello et al. Chem. Mater., 4, 692, (1992) reports that the order of reactivity among commonly used nucleophilic anions is SbF₆>AsF₆>PF₆>BF₄. The influence of the anion on reactivity has been ascribed to three principle factors which the skilled artisan should compensate for in the present invention: (1) the acidity of the protonic or Lewis acid generated; (2) the degree of ion-pair separation in the propagating cationic chain; and, (3) the susceptibility of the anions to fluoride abstraction and consequent chain termination.

In preferred embodiments, the photoinitiator c) either consists essentially of or consists of said photoacid generator. That said, it is not completely precluded that the compositions of the present invention include alternative photoinitiator compounds to photoacid generator compounds mentioned herein above, which photoinitiator compound(s) would initiate the polymerization or hardening of the compositions upon irradiation.

It is noted that photo-curable compositions of the present invention are cationically polymerizable and, in certain circumstances, free-radically polymerizable: whilst epoxy groups are cationically active, the election of a free-radical polymerization mechanism imposes the requirement that the composition must contain a compound possessing a free-radically active, unsaturated group such as an acrylate compound, a (meth)acrylate compound, an epoxy-functional acrylate, an epoxy functional (meth)acrylate or a combination thereof. Applying that election, the preferred supplementary photoinitiator compounds would be photoactive compounds that undergo a Norrish I cleavage to generate free radicals that can initiate by addition to the C═C double bonds.

In toto photoinitiator c) should be present in the photo-curable composition in amount of from 0.1 to 10 wt. %, for example from 0.5 to 5.0 wt. % or from 0.5 to 2.5 wt. %, based on the total weight of the composition.

The purpose of irradiation is to generate the active species from the photoinitiator which initiates the cure reactions. Once that species is generated, the cure chemistry is subject to the same rules of thermodynamics as any chemical reaction: the reaction rate may be accelerated by heat. The practice of using thermal treatments to enhance the cationic UV cure of monomers is generally known in the art, with an illustrative instructive reference being Crivello et al., “Dual Photo- and thermally initiated cationic polymerization of epoxy monomers,” Journal of Polymer Science A, Polymer Chemistry., Vol. 44, Issue: 23, pp. 6750-6764, (Dec. 1, 2006).

As would be recognized by the skilled artisan, photosensitizers can be incorporated into the compositions to improve the efficiency with which the photoinitiator c) uses the energy delivered. The term “photosensitizes” is used in accordance with its standard meaning to represent any substance that either increases the rate of photoinitiated polymerization or shifts the wavelength at which polymerization occurs: Odian, Principles of Polymerization 3rd Edition (1991), Page 222 provides an instructive reference in this regard. When present, photosensitizers should be used in an amount of from 5 to 25 wt. %, based on the weight of the photoinitiator c).

The use of the photoinitiator c)—and where applicable a photosensitizer—may produce residue compounds from the photochemical reaction in the final cured product. The residues may be detected by conventional analytical techniques such as: infrared, ultraviolet and NMR spectroscopy; gas or liquid chromatography; and mass spectroscopy. Thus, the present invention may comprise cured (epoxy) matrix copolymers and detectable amounts of residues from at least the photo-acid generator. Such residues are present in small amounts and do not normally interfere with the desired physiochemical properties of the final cured product.

### Part d): Optional Curative Component

The composition of the present invention may optionally comprise a hardener constituted by a compound which possesses at least two epoxide reactive groups per molecule. In particular, the hardener or curative should comprise one or both of:
i) at least one polyamine having at least two amine hydrogens reactive toward epoxide groups; and,
ii) at least one mercapto compound having at least two mercapto groups reactive toward epoxide groups.

In a first embodiment, the hardener comprises or consists of at least one polyamine having at least two amine hydrogens reactive toward epoxide groups. In particular, the desired polyamine hardener may contain primary and/or secondary amine groups and have an equivalent weight per primary or secondary amine group of not more than 150, preferably not more than 125.

Suitable polyamines for use in the present invention, which may be used alone or in combination, include but are not limited to the following.

i) Aliphatic, cycloaliphatic or arylaliphatic primary diamines of which the following examples may be mentioned: 2,2-dimethyl-1,3-propanediamine; 1,3-pentanediamine (DAMP); 1,5-pentanediamine; 1,5-diamino-2-methylpentane (MPMD); 2-butyl-2-ethyl-1,5-pentanediamine (C11-neodiamine); 1,6-hexanediamine (hexamethylenediamine, HMDA); 2,5-dimethyl-1,6-hexanediamine; 2,2,4- and/or 2,4,4-trimethylhexamethylenediamine; 1,7-heptanediamine; 1,8-octanediamine; 1,9-nonanediamine; 1,10-decanediamine; 1,11-undecanediamine; 1,12-dodecanediamine; 1,2-, 1,3- and 1,4-diaminocyclohexane; bis(4-aminocyclohexyl)methane; bis(4-amino-3-methylcyclohexyl)methane; bis(4-amino-3-ethylcyclohexyl)methane; bis(4-amino-3,5-dimethylcyclohexyl)methane; bis(4-amino-3-ethyl-5-methylcyclohexyl)methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)-cyclohexane; 1,4-bis(aminomethyl)cyclohexane; 2,5(2,6)-bis(aminomethyl)-bicyclo[2.2.1]heptane (norborane diamine, NBDA); 3(4),8(9)-bis(aminomethyl)tricyclo[5.2.1.0^{2,6}]-decane (TCD-diamine); 1,4-diamino-2,2,6-trimethylcyclohexane (TMCDA); 1,8-menthanediamine; 3,9-bis(3-aminopropyl)-2,4,8,10-tetraoxaspiro[5.5]undecane; and, 1,3-bis(aminomethyl)benzene (MXDA).

ii) Tertiary amine group-containing polyamines with two or three primary aliphatic amine groups of which the following specific examples may be mentioned: N,N′-bis(aminopropyl)-piperazine; N,N-bis(3-aminopropyl)methylamine; N,N-bis(3-aminopropyl)ethylamine; N,N-bis(3-aminopropyl)propylamine; N,N-bis(3-aminopropyl)cyclohexylamine; N,N-bis(3-aminopropyl)-2-ethyl-hexylamine; tris(2-aminoethyl)amine; tris(2-aminopropyl)amine; tris(3-aminopropyl)amine; and, the products from the double cyanoethylation and subsequent reduction of fatty amines derived from natural fatty acids, such as N,N-bis(3-aminopropyl)dodecylamine and N,N-bis(3-aminopropyl)tallow alkylamine, commercially available as Triameen® Y12D and Triameen® YT (from Akzo Nobel).

iii) Ether group-containing aliphatic primary polyamines of which the following specific examples may be mentioned: bis(2-aminoethyl)ether; 3,6-dioxaoctane-1,8-diamine; 4,7-dioxadecane-1,10-diamine; 4,7-dioxadecane-2,9-diamine; 4,9-dioxadodecane-1,12-diamine; 5,8-dioxadodecane-3,10-diamine; 4,7,10-trioxatridecane-1,13-diamine and higher oligomers of these diamines; bis(3-aminopropyl)polytetrahydrofuranes and other polytetrahydrofuran diamines; cycloaliphatic ether group-containing diamines obtained from the propoxylation and subsequent amination of 1,4-dimethylolcyclohexane, such as that material commercially available as Jeffamine® RFD-270 (from Huntsman); polyoxyalkylenedi- or -triamines obtainable as products from the amination of polyoxyalkylenedi- and -triols and which are commercially available under the name of Jeffamine® (from Huntsman), under the name of polyetheramine (from BASF) or under the name of PC Amines® (from Nitroil). A particular preference may be noted for the use of Jeffamine® D-230, Jeffamine® D-400, Jeffamine® D-600, Jeffamine® D-2000, Jeffamine® D-4000, Jeffamine® T-403, Jeffamine® T-3000, Jeffamine® T-5000, Jeffamine® EDR-104, Jeffamine® EDR-148 and Jeffamine® EDR-176, as well as corresponding amines from BASF or Nitroil.

iv) Primary diamines with secondary amine groups of which the following examples may be mentioned: 3-(2-aminoethyl)aminopropylamine, bis(hexamethylene)triamine (BHMT); diethylenetriamine (DETA); triethylenetetramine (TETA); tetraethylenepentamine (TEPA); pentaethylenehexamine (PEHA); higher homologs of linear polyethyleneamines, such as polyethylene polyamines with 5 to 7 ethyleneamine units (so-called “higher ethylenepolyamine,” HEPA); products from the multiple cyanoethylation or cyanobutylation and subsequent hydrogenation of primary di- and polyamines with at least two primary amine groups, such as dipropylenetriamine (DPTA), N-(2-aminoethyl)-1,3-propanediamine (N3-amine), N,N′-bis(3-aminopropyl)ethylenediamine (N4-amine), N,N′-bis(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine or N,N′-bis(3-amino-1-ethylpropyl)-2-methyl-1,5-pentanediamine.

v) Polyamines with one primary and at least one secondary amino group of which the following examples may be mentioned: N-butyl-1,2-ethanediamine; N-hexyl-1,2-ethanediamine; N-(2-ethylhexyl)-1,2-ethanediamine; N-cyclohexyl-1,2-ethanediamine; 4-aminomethyl-piperidine; N-(2-aminoethyl)piperazine; N-methyl-1,3-propanediamine; N-butyl-1,3-propanediamine; N-(2-ethylhexyl)-1,3-propanediamine; N-cyclohexyl-1,3-propanediamine; 3-methylamino-1-pentylamine; 3-ethylamino-1-pentylamine; 3-cyclohexylamino-1-pentylamine; fatty diamines such as N-cocoalkyl-1,3-propanediamine; products from the Michael-type addition reaction of primary aliphatic diamines with acrylonitrile, maleic or fumaric acid diesters, citraconic acid diesters, acrylic and methacrylic acid esters, acrylic and methacrylic acid amides and itaconic acid diesters, reacted in a 1:1 molar ratio; products from the partial reductive alkylation of primary polyamines with aldehydes or ketones, especially N-monoalkylation products of the previously mentioned polyamines with two primary amine groups and in particular of 1,6-hexanediamine, 1,5-diamino-2-methylpentane, 1,3-bis(aminomethyl)cyclohexane, 1,4-bis(aminomethyl)cyclohexane, 1,3-bis(aminomethyl)benzene, BHMT, DETA, TETA, TEPA, DPTA, N3-amine and N4-amine, wherein preferred alkyl groups are benzyl, isobutyl, hexyl and 2-ethylhexyl; and, partially styrenated polyamines such as those commercially available as Gaskamine® 240 (from Mitsubishi Gas Chemical).

vi) Secondary diamines and, in particular, N,N′-dialkylation products of the previously mentioned polyamines with two primary amine groups, especially N,N′-dialkylation products of 1,6-hexanediamine, 1,5-diamino-2-methylpentane, 1,3-bis(aminomethyl)cyclohexane, 1,4-bis(aminomethyl)-cyclohexane, 1,3-bis(aminomethyl)benzene, BHMT, DETA, TETA, TEPA, DPTA, N3-amine or N4-amine, wherein preferred alkyl groups are 2-phenylethyl, benzyl, isobutyl, hexyl and 2-ethylhexyl.

vii) Aromatic polyamines of which mention may be made of: m- and p-phenylenediamine; 4,4′-, 2,4′ and 2,2′-diaminodiphenylmethane; 3,3′-dichloro-4,4′-diaminodiphenylmethane (MOCA); 2,4- and 2,6-tolylenediamine; mixtures of 3,5-dimethylthio-2,4- and -2,6-tolylenediamine (available as Ethacure® 300 from Albermarle); mixtures of 3,5-diethyl-2,4- and -2,6-tolylene diamine (DETDA); 3,3′,5,5′-tetraethyl-4,4′-diaminodiphenylmethane (M-DEA); 3,3′,5,5′-tetraethyl-2,2′-dichloro-4,4′-diaminodiphenylmethane (M-CDEA); 3,3′-diisopropyl-5,5′-dimethyl-4,4′-diaminodiphenylmethane (M-MIPA); 3,3′,5,5′-tetraisopropyl-4,4′-diaminodiphenylmethane (M-DIPA); 4,4′-diamino diphenyl-sulfone (DDS); 4-amino-N-(4-aminophenyl)benzenesulfonam ide; 5,5′-methylenedianthranilic acid; dimethyl-(5,5′-methylenedianthranilate); 1,3-propylene-bis(4-aminobenzoate); 1,4-butylene-bis(4-aminobenzoate); polytetramethylene oxide-bis(4-aminobenzoate) (available as Versalink® from Air Products); 1,2-bis(2-aminophenylthio)ethane, 2-methylpropyl-(4-chloro-3,5-diaminobenzoate); and, tert.butyl-(4-chloro-3,5-diaminobenzoate).

viii) Polyamidoamines of which indicative members include the reaction products of monohydric or polyhydric carboxylic acids or the esters or anhydrides thereof, —in particular dimer fatty acids—and an aliphatic, cycloaliphatic or aromatic polyamine, for instance polyalkyleneamines such as DETA or TETA. Commercially available polyamidoamines include: Versamid® 100, 125, 140 and 150 (from Cognis); Aradur® 223, 250 and 848 (from Huntsman); Euretek® 3607 and 530 (from Huntsman); and, Beckopox® EH 651, EH 654, EH 655, EH 661 and EH 663 (from Cytec).

ix) Mannich bases and in particular the commercially available phenalkamines Cardolite® NC-541, NC-557, NC-558, NC-566, Lite 2001 and Lite 2002 (available from Cardolite), Aradur® 3440, 3441, 3442 and 3460 (available from Huntsman) and Beckopox® EH 614, EH 621, EH 624, EH 628 and EH 629 (available from Cytec).

Preferred among the aforementioned polyamines having at least two primary aliphatic amine groups are: isophorone diamine (IPDA); hexamethylene diamine (NMDA); 1,3-bis(amino-methyl)cyclohexane; 1,4-bis(aminomethyl)cyclohexane; bis(4-amino-cyclohexyl)methane; bis(4-amino-3-methylcyclohexyl)methane; NBDA; and, ether group-containing polyamines with an average molecular weight of up to 500 g/mol. Particularly preferred among said ether group-containing polyamines are Jeffamine® D-230 and D-600 (available from Huntsman).

In an expression of the preferred amount of part d) i) above, the composition may be characterized by comprising from 0 to 10 wt. %, preferably from 0 to 5 wt. % of said polyamine curing agent.

As a curative, the composition of the present invention may comprise at least one compound which has at least two reactive mercapto-groups per molecule. Suitable mercapto-group containing compounds, which may be used alone or in combination, include but are not limited to the following.
Liquid mercaptan-terminated polysulfide polymers of which commercial examples include: Thiokol® polymers (available from Morton Thiokol), in particular the types LP-3, LP-33, LP-980, LP-23, LP-55, LP-56, LP-12, LP-31, LP-32 and LP-2 thereof; and, Thioplast® polymers (from Akzo Nobel), in particular the types G10, G112, G131, G1, G12, G21, G22, G44 and G 4.
Mercaptan-terminated polyoxyalkylene ethers, obtainable by reacting polyoxyalkylenedi- and -triols either with epichlorohydrin or with an alkylene oxide, followed by sodium hydrogen sulfide.
Mercaptan-terminated compounds in the form of polyoxyalkylene derivatives, known under the trade name of Capcure® (from Cognis), in particular the types WR-8, LOF and 3-800 thereof.
Polyesters of thiocarboxylic acids of which particular examples include: pentaerythritol tetramercapto-acetate (PETMP); trimethylolpropane trimercaptoacetate (TMPMP); glycol dim ercaptoacetate; and the esterification products of polyoxyalkylene diols and triols, ethoxylated trimethylolpropane and polyester diols with thiocarboxylic acids such as thioglycolic acid and 2- or 3-mercaptopropionic acid.
2,4,6-trimercapto-1,3,5-triazine, 2,2′-(ethylenedioxy)-diethanethiol (triethylene glycol dimercaptan) and/or ethanedithiol.

A preference for the use of polyesters of thiocarboxylic acids and, in particular, for the use of at least one of pentaerythritol tetramercapto-acetate (PETMP), trimethylolpropane trimercaptoacetate (TMPMP) and glycol dimercaptoacetate is acknowledged.

In an expression of the preferred amount of part d) ii) above, the composition may be characterized by comprising from 0 to 10 wt. %, preferably from 0 to 5 wt. % of said at least one mercapto compound.

### Part e): Additives and Adjunct Ingredients

Said compositions obtained in the present invention—which can be formulated as either one component (1K) or two component compositions—will typically further comprise adjuvants and additives that can impart improved properties to these compositions. For instance, the adjuvants and additives may impart one or more of: improved elastic properties; improved elastic recovery; longer enabled processing time; faster curing time; and, lower residual tack. Included among such adjuvants and additives—which independently of one another may be included in single components or both components of a two (2K) component composition—are catalysts, plasticizers, stabilizers including UV stabilizers, antioxidants, secondary tougheners, secondary fillers, reactive diluents, drying agents, adhesion promoters, fungicides, flame retardants, rheological adjuvants, color pigments or color pastes, and/or optionally also, to a small extent, non-reactive diluents.

For completeness, it is noted that in general adjunct materials and additives which contain epoxide-reactive groups will be blended into the hardener (curative) component of a two (2K) component composition. Materials that contain epoxide groups or which are reactive with the hardener(s) are generally formulated into the epoxide-containing component of a two (2K) component composition. Unreactive materials may be formulated into either or both of the components.

Catalysts may be incorporated to promote the reaction between the epoxide groups and any epoxide-reactive groups which might be present in the composition: they may, for instance promote the reaction between the amine groups (part d)i)) and the epoxide groups. A further specific example relates to the use of an amine catalyst which functions by de-protonation of reactive thiol (—SH) groups present to thiolate (—S″), which thiolate reacts with epoxy group by nucleophilic ring opening polymerization.

Without intention to the limit the catalysts used in the present invention, mention may be made of the following suitable catalysts: i) acids or compounds hydrolyzable to acids, in particular a) organic carboxylic acids, such as acetic acid, benzoic acid, salicylic acid, 2-nitrobenzoic acid and lactic acid; b) organic sulfonic acids, such as methanesulfonic acid, p-toluenesulfonic acid and 4-dodecylbenzenesulfonic acid; c) sulfonic acid esters; d) inorganic acids, such as phosphoric acid; e) Lewis acid compounds, such as BF₃ amine complexes, SbF₆ sulfonium compounds, bis-arene iron complexes; and, f) mixtures of the aforementioned acids and acid esters; ii) tertiary amines, such as 1,4-diazabicyclo[2.2.2]octane, benzyldimethylamine, α-methylbenzyl dimethylamine, triethanolamine, dimethylamino propylamine, imidazoles—including N-methylimidazole, N-vinylimidazole and 1,2-dimethylimidazole—and salts of such tertiary amines; iii) quaternary ammonium salts, such as benzyltrimethyl ammonium chloride; iv) am idines, such as 1,8-diazabicyclo[5.4.0]undec-7-ene; v) guanidines, such as 1,1,3,3-tetramethylguanidine; vi) phenols, in particular bisphenols; vii) phenol resins; viii) Mannich bases; and, ix) phosphites, such as di- and triphenylphosphites.

The skilled artisan will be able to determine an appropriate catalytic amount of the catalyst(s). However, on the basis of their functionality, said catalyst(s) should be included in an amount of from 0 to 5 wt. %, preferably 0 to 2 wt. % based on the weight in the composition of compounds bearing epoxide-reactive groups.

A “plasticizer” for the purposes of this invention is a substance that decreases the viscosity of the composition and thus facilitates its processability. Herein the plasticizer may constitute up to 10 wt. % or up to 5 wt. %, based on the total weight of the composition, and is preferably selected from the group consisting of: polydimethylsiloxanes (PDMS); diurethanes; ethers of monofunctional, linear or branched C4-C16 alcohols, such as Cetiol OE (obtainable from Cognis Deutschland GmbH, Düsseldorf); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; epoxidized plasticizers; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer, but these are not preferred due to their toxicological potential. It is preferred that the plasticizer comprises or consists of one or more polydimethylsiloxane (PDMS).

“Stabilizers” for purposes of this invention are to be understood as antioxidants, UV stabilizers or hydrolysis stabilizers. Herein stabilizers may constitute in toto up to 10 wt. % or up to 5 wt. %, based on the total weight of the composition. Standard commercial examples of stabilizers suitable for use herein includes; sterically hindered phenols; thioethers; benzotriazoles; benzophenones; benzoates; cyanoacrylates; acrylates; amines of the hindered amine light stabilizer (HALS) type; phosphorus; sulfur; and mixtures thereof.

The compositions of the present invention may comprise supplementary fillers to those mentioned hereinabove in parts a) and b) but, in order not to be deleterious to the optical properties of the cured resin, the amount of said supplementary fillers should be less than 5 wt. %, for instance less than 2 wt. % or even less than 1 wt. % based on the weight of the composition. Noting that compositional limitation, the skilled artisan will recognize that the desired viscosity of the curable composition will also be determinative of the total amount of supplementary filler actually added. It is submitted that in order to be readily extrudable out of a suitable printing apparatus—as discussed below—the curable compositions should possess a viscosity of from 3000 to 150,000, preferably from 10,000 to 80,000 m Pas.

Suitable here are, for example, chalk, lime powder, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

Also, suitable as supplementary fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less.

Supplementary fillers which impart thixotropy to the composition may be preferred for many applications: such fillers are also described as rheological adjuvants, e.g., hydrogenated castor oil, fatty acid amides, or swellable plastics such as PVC.

Examples of suitable pigments are titanium dioxide, iron oxides, or carbon black.

In order to enhance shelf life even further, it is often advisable to further stabilize the compositions of the present invention with respect to moisture penetration through using drying agents. A need also occasionally exists to lower the viscosity of an adhesive or sealant composition according to the present invention for specific applications, by using reactive diluent(s). When present, the total amount of reactive diluents present will typically be up to 15 wt. %, and preferably up to 5 wt. %, based on the total weight of the composition.

The presence of non-reactive diluents in the compositions of the present invention is also not precluded where this can usefully moderate the viscosities thereof. For instance, but for illustration only, the compositions may contain one or more of: xylene; 2-methoxyethanol; dimethoxyethanol; 2-ethoxyethanol; 2-propoxyethanol; 2-isopropoxyethanol; 2-butoxyethanol; 2-phenoxyethanol; 2-benzyloxyethanol; benzyl alcohol; ethylene glycol; ethylene glycol dimethyl ether; ethylene glycol diethyl ether; ethylene glycol dibutyl ether; ethylene glycol diphenyl ether; diethylene glycol; diethylene glycol-monomethyl ether; diethylene glycol-monoethyl ether; diethylene glycol-mono-n-butyl ether; diethylene glycol dimethyl ether; diethylene glycol diethyl ether; diethylene glycoldi-n-butylyl ether; propylene glycol butyl ether; propylene glycol phenyl ether; dipropylene glycol; dipropylene glycol monomethyl ether; dipropylene glycol dimethyl ether; dipropylene glycoldi-n-butyl ether; N-methylpyrrolidone; diphenylmethane; diisopropylnaphthalene; petroleum fractions such as Solvesso® products (available from Exxon); alkylphenols, such as tert-butylphenol, nonylphenol, dodecylphenol and 8,11,14-pentadecatrienylphenol; styrenated phenol; bisphenols; aromatic hydrocarbon resins especially those containing phenol groups, such as ethoxylated or propoxylated phenols; adipates; sebacates; phthalates; benzoates; organic phosphoric or sulfonic acid esters; and sulfonamides.

The above aside, it is preferred that said non-reactive diluents constitute less than 10 wt. %, in particular less than than 5 wt. % or less than 2 wt. %, based on the total weight of the composition.

### Illustrative Embodiment of the Invention

Without intention to limit the present invention, good results have been obtained where the photo-curable composition for use in additive manufacturing comprises:

from 40 to 60 wt. % of a) a dispersion of nanosilica particles in epoxy resin, said nanosilica particles having an average particle size (d50) of less than 50 nm, as measured by dynamic light scattering, and said epoxy resin being comprised of at least one polyepoxide compound selected from the group consisting of glycidyl ethers of polyhydric alcohols, gycidyl ethers of polyhydric phenols and glycidyl esters of polycarboxylic acids;

from 40 to 60 wt. % of b) a toughened epoxy resin comprising
i) core shell rubber particles having an average particle size (d50) of from 10 to 300 nm, as measured via dynamic light scattering; and,
ii) at least one cycloaliphatic epoxy resin selected from the group consisting of: cyclohexanedimethanol diglycidyl ether; bis(3,4-epoxycyclohexylm ethyl) adipate; bis(3 4-epoxy-6-methylcyclohexylmethyl) adipate; bis(2,3-epoxycyclopentyl) ether; 3,4-epoxycyclohexylmethyl; 3,4-epoxycyclohexanecarboxylate; 1,4-cyclohexanedimethanol diglycidyl ether; diglycidyl 1,2-cyclohexanedicarboxylate; and, cycloaliphatic epoxy resins obtained by the hydrogenation of aromatic bisphenol A diglycidyl ether (BADGE) epoxy resins; and

from 0.5 to 5 wt. % of c) a photoinitatior, said photoinitator consisting of an ionic photoacid generator ionic photoacid generator which is a salt selected from the group consisting of: hexafluoroantimonate salts; hexafluoroarsenate salts; hexafluorophosphate salts; and, tetrafluoroborate salts.

### Preparation of the Compositions

To form a composition, the above described parts are brought together and mixed. As is known in the art, to form one component (1K) curable compositions, the elements of the composition are brought together and homogeneously mixed under conditions which inhibit or prevent the reactive components from reacting: as would be readily comprehended by the skilled artisan, this might include mixing conditions which limit or prevent exposure to moisture or irradiation or which limit or prevent the activation of a constituent latent catalyst. As such, it will often be preferred that the curative elements are not mixed by hand but are instead mixed by machine—a static or dynamic mixer, for example—in pre-determined amounts under anhydrous conditions without intentional photo-irradiation.

For the two component (2K) compositions, the reactive components are brought together and mixed in such a manner as to induce the hardening thereof. For both one (1K) and two (2K) component compositions, the reactive compounds should be mixed under sufficient shear forces to yield a homogeneous dispersion of the colloidal silica sol (part a)) within the composition as a whole but not to destabilize the dispersion of the nanosilica within its matrix epoxy resin. It is considered that this can be achieved without special conditions or special equipment. That said, suitable mixing devices might include: static mixing devices; magnetic stir bar apparatuses; wire whisk devices; augers; batch mixers; planetary mixers; C. W. Brabender or Banburry® style mixers; and, high shear mixers, such as blade-style blenders and rotary impellers.

For small-scale liner applications in which volumes of less than 2 liters will generally be used, the preferred packaging for the two component (2K) compositions will be side-by-side double cartridges or coaxial cartridges, in which two tubular chambers are arranged alongside one another or inside one another and are sealed with pistons: the driving of these pistons allows the components to be extruded from the cartridge, advantageously through a closely mounted static or dynamic mixer. For larger volume applications, the two components of the composition may advantageously be stored in drums or pails: in this case the two components are extruded via hydraulic presses, in particular by way of follower plates, and are supplied via pipelines to a mixing apparatus which can ensure fine and highly homogeneous mixing of the hardener and binder components. In any event, for any package it is important that the binder component be disposed with an airtight and moisture-tight seal, so that both components can be stored for a long time, ideally for 12 months or longer.

Non-limiting examples of two component dispensing apparatuses and methods that may be suitable for the present invention include those described in U.S. Pat. Nos. 6,129,244 and 8,313,006.

Where applicable, two (2K) component compositions should broadly be formulated to exhibit an initial viscosity—determined immediately after mixing, for example, up to two minutes after mixing—of less than 200000 mPa·s, for instance less than 100000 mPa·s, at 25° C. Independently of or additional to said viscosity characteristics, the two (2K) component composition should be formulated to be bubble (foam) free upon mixing and subsequent curing. Moreover, the two component (2K) composition should further be formulated to demonstrate at least one, desirably at least two and most desirably all of the following properties: i) a long pot life, typically of at least 30 minutes and commonly of at least 60 or 120 minutes, which pot life should be understood herein to be the time after which the viscosity of a mixture at 20° C. will have risen to more than 50,000 mPas; ii) a maximum exotherm temperature of no greater than 120° C., preferably no greater than 100° C. and more preferably no greater than 80° C.; and, iii) a Shore A hardness of at least 50, preferably at 60 and more preferably at least 70 after being cured and stored for 7 days at room temperature and 50% relative humidity.

### Methods and Applications

In accordance with the broadest process aspects of the present invention, the above described compositions are applied to a substrate and then cured in situ. Prior to applying the compositions, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

In some embodiments, the adhesion of the coating compositions of the present invention to the preferably pre-treated substrate may be facilitated by the application of a primer thereto. Whilst the skilled artisan will be able to select an appropriate primer, instructive references for the choice of primer include but are not limited to: U.S. Pat. Nos. 3,671,483; 4,681,636; 4,749,741; 4,147,685; and 6,231,990.

The compositions are then applied to the preferably pre-treated, optionally primed surfaces of the substrate. And, as noted above, in a preferred embodiment of the present invention, this application is effected by additive manufacturing methods.

Most broadly, two techniques are known for additive manufacturing are known and may be utilized in the present invention: a first in which new layers are formed at the top surface of the growing object; a second method in which new layers are formed at the bottom surface of the growing object. The teaching of the following documents may be instructive in the regard: U.S. Pat. No. 5,236,637 (Hull); U.S. Pat. Nos. 7,438,846; 7,892,474; US 2013/0292862 A1 (Joyce); US 2013/0295212 A1 (Chen et al.); and Pan et al., J. Manufacturing Sci. and Eng. 134, 051011-1 (October 2012).

In a typical mode of application, the method of the present invention comprises the step of printing the above defined composition with a 3D printer, irradiating the composition so that it at least partially cures thereon to form a coating layer on the substrate. The resultant layer formed by 3D printing is desirably both continuous and of consistent thickness.

In an important embodiment, the present method incorporates the steps of: i) providing a carrier and an optically transparent member having a movable build surface, said carrier and build surface defining a build region there between; ii) within said build region, applying by 3D printing a first layer of the composition as defined herein above and in the appended claims; iii) irradiating said build region through said optically transparent member to at least partially cure that first layer; iv) applying a subsequent layer of said composition as defined herein above and in the appended claims by 3D printing on the at least partially cured layer; and, v) irradiating said build region through said optically transparent member to at least partially cure that subsequent layer. In an iterative process, steps iii) and iv) may be performed and repeated so as to dispose second, third, fourth and further layers on the substrate.

As used herein, the term “at least partially cured” means that curing of the curable coating composition has been initiated and that, for example, cross-linking of components of the composition has commenced. The term encompasses any amount of cure upon application of the curing condition, from the formation of a single cross-link to a fully cross-linked state. Obviously, the rate and mechanism with which the coating composition cures is contingent on various factors, including the components thereof, functional groups of the components and the parameters of the curing condition.

At least partial solidification of a given coating layer is generally indicative of cure or drying. However, both drying and cure may be indicated in other ways including, for instance, a viscosity change of the coating layer, an increased temperature of that coating layer and/or a transparency/opacity change of that coating layer. It may be desirable for the or each step iii) of the above described application process to be commenced only when the at least partially cured or partially dried preceding layer can substantially retain its shape upon exposure to ambient conditions. By “substantially retains its shape” it is meant that at least 50% by volume, and more usually at least 80% or 90% by volume of the at least partially cured or dried layer retains its shape and does not flow or deform upon exposure to ambient conditions for a period of 5 minutes. Under such circumstances, gravity should not therefore substantially impact the shape of the at least partially cured or partially dried layer upon exposure to ambient conditions.

For completeness, the shape of the at least partially dried or at least partially cured layer will impact whether said layer substantially retains its shape. For example, when said layer is rectangular or has another simplistic shape, the at least partially cured or dried layer may be more resistant to deformation at even lesser levels of cure or even lesser degrees of drying than layers having more complex shapes.

In certain embodiments, the 3D-printing of the subsequent layer (step iii)) occurs before an at least partially cured layer has reached a final cured state, nominatively while the layer is still “green.” In such embodiments, printing of the layers may be considered “wet-on-wet” such that the adjacent layers at least physically bond, and may also chemically bond, to one another. For example, it is possible that components in each of the first and subsequent layers can chemically cross-link/cure across the print line, which effect can be beneficial to the longevity, durability and appearance of the 3D article. Importantly, the distinction between partial cure and a final cured state is whether the partially cured layer can undergo further curing or cross-linking. This does not actually preclude functional groups being present in the final cure state but such groups may remain un-reacted due to steric hindrance or other factors.

In the aforementioned iterative process, the thickness, width, shape and continuity of each layer may be independently selected such that the or each preceding and subsequent layer may be the same or different from one another in one or more of these regards. For example, a given subsequent layer may only contact a portion of an exposed surface of the at least partially cured or dried preceding layer: depending on the desired shape of the coating layer, the subsequent layer may build on that layer selectively.

The thickness and/or width tolerances of the or each layer may depend on the 3D printing process used, with certain printing processes having high resolutions and others having low resolutions. Whilst the present disclosure is not limited to any particular dimensions of any of the layers, it is recommended that the compositions be applied to a wet film thickness of from 10 to 5000 μm or from 10 to 1000 μm. The application of thinner layers within this range is more economical but great control must be exercised in applying thinner layers to avoid the formation of discontinuous cured or dried films.

There is no particular intention to limit the types of 3D printers and/or 3D printing methodologies which may be utilized in the present invention. For instance, a suitable 3D printer may be selected from: fused filament fabrication printers; selective laser sintering printers; selective laser melting printers; stereolithography printers; powder-bed (binder jet) printers; material jet printers; direct metal laser sintering printers; electron beam melting printer; laminated object manufacturing deposition printers; directed energy deposition printers; laser powder forming printers; polyjet printers; ink-jetting printers; material jetting printers; and, syringe extrusion printer. It is further noted that the 3D printer may be independently selected during each printing step of an iterative process when employed in the present method: thus, if desired, each printing step of an iterative process may utilize a different 3D printer such that different characteristics are imparted with respect to distinct layers.

For solvent borne compositions which yield a film upon drying, any required drying step can of course be accelerated by the application of an elevated temperature, for instance a temperature in the range of from 50° C. to 150° C. or from 50° C. to 120° C. Conduction, convection and/or induction heating methods may be employed in this context. The use of forced air in conjunction with heating may be beneficial to the drying process in certain circumstances.

As will be recognized by the skilled artisan, any requisite step or, in an iterative process, each drying step for a solvent borne composition need not be performed in a single, continuous manner. It can be advantageous, for example, to apply heat in a first stage up until the onset of coating coalescence and while the coating composition remains fluid-like: in such a state, the coating may hold fillers, including microspheres in place, but will also flow sufficiently to enable it to become leveled on the substrate. Heat may then subsequently be applied again to a temperature sufficient to further drive the solvent off from the coating composition.

Conventionally, the energy source used to cure radiation curable compositions will emit at least one of ultraviolet (UV) radiation, infrared (IR) radiation, visible light, X-rays, gamma rays, or electron beams (e-beam). Subsequent to their application by 3D-printing, the radiation curable compositions may typically be activated in less than 5 minutes, and commonly between 1 and 60 seconds—for instance between 3 and 12 seconds—when irradiated using commercial curing equipment.

Irradiating ultraviolet light should typically have a wavelength of from 150 to 600 nm and preferably a wavelength of from 200 to 450 nm. Useful sources of UV light include, for instance, extra high pressure mercury lamps, high pressure mercury lamps, medium pressure mercury lamps, low intensity fluorescent lamps, metal halide lamps, microwave powered lamps, xenon lamps, UV-LED lamps and laser beam sources such as excimer lasers and argon-ion lasers.

Where an e-beam is utilized to cure the layer(s), standard parameters for the operating device may be: an accelerating voltage of from 0.1 to 100 keV; a vacuum of from 10 to 10⁻³ Pa; an electron current of from 0.0001 to 1 ampere; and, power of from 0.1 watt to 1 kilowatt.

The amount of radiation necessary to cure an individual, radiation curable composition will depend on a variety of factors including the angle of exposure to the radiation and the thickness of a coating layer. Broadly however, a curing dosage of from 5 to 10000 mJ/cm² may be cited as being typical: curing dosages of from 50 to 1000 mJ/cm², such as from 50 to 500 mJ/cm² may be considered highly effective.

The curing of the so-printed curable compositions should typically occur at temperatures in the range of from −10° C. to 120° C., preferably from 0° C. to 70° C., and in particular from 20° C. to 60° C. The temperature that is suitable depends on the specific compounds present and the desired curing rate and can be determined in the individual case by the skilled artisan, using simple preliminary tests if necessary. Of course, curing at temperatures of from 10° C. to 35° C. or from 20° C. to 30° C. are especially advantageous as they obviate the requirement to substantially heat or cool the mixture from the usually prevailing ambient temperature. Where applicable, however, the temperature of the curable compositions may be raised above the mixing temperature and/or the application temperature using conventional means, including microwave induction.

The following examples are illustrative of the present invention and are not intended to limit the scope of the invention in any way.

### EXAMPLES

The following compounds are employed in the Examples:

NANOPDX® E 430: Silica reinforced epoxy resin based on a mixture of bisphenol A and F diglycidyl ether, available from Evonik

NANOPDX® E 601: Silica reinforced cycloaliphatic epoxy resin, available from Evonik

Kane Ace® MX553 Cycloaliphatic epoxy resin reinforced with Core Shell rubber particles available from Kaneka Corporation

UVI-6976: Cationic photoinitiator containing a mixture of triarylsulfonium hexafluoroantimonate salts in propylene carbonate available from The Dow Chemical Company

The following compositions as defined in Table 1 were prepared under mixing using a rotation revolution mixer, Thinky A-250:

TABLE 1

| | Percentage by Weight of Composition (wt. %) | |
|---|---|---|
| Ingredient | Example 1 | Example 2 |
| Nanopox E601 | 49 | |
| Nanopox E430 | | 49 |
| Kana Ace MX 553 | 49 | 49 |
| UVI-6976 | 2 | 2 |

The compositions were applied to a rigid planar Teflon substrate using a stereolithography (SLA) additive manufacturing technique employing a Form labs Form 2 3D-printer.

The printed compositions had an initial viscosity of 4800 cps at 25° C. (Example 1) and 8100 cps at 25° C. (Example 2) and were each exposed to UV light irradiation using a High Pressure Mercury Lamp for 60 seconds (6000 mJ/cm² dosage) and then left at room temperature to obtain the rigid, cured resins. The compositions were allowed to dry in air to a dry film thickness of from 400 to 500 μm: the dried coating layers were characterized by a Shore D hardness of 85±3. The dried coating layers were also optically clear.

In view of the foregoing description and example, it will be apparent to those skilled in the art that equivalent modifications thereof can be made without departing from the scope of the claims.

What is claimed is:

1. A photo-curable composition for use in additive manufacturing, said composition comprising, based on the total weight of the composition:
from 10 to 80 wt. % of a) a dispersion of nanosilica particles in epoxy resin, said nanosilica particles having an average particle size (d50) of less than 50 nm, as measured by dynamic light scattering;
from 10 to 80 wt. % of b) a toughened epoxy resin comprising
i) core shell rubber particles; and,
ii) at least one cycloaliphatic epoxy resin; and,
from 0.1 to 10 wt. % of c) a photoinitatior, said photoinitator comprising an ionic photoacid generator.

2. The photo-curable according to claim 1 comprising, based on the total weight of the composition:
from 25 to 65 wt. % of a) a dispersion of nanosilica particles in epoxy resin, said nanosilica particles having an average particle size (d50) of less than 50 nm, as measured by dynamic light scattering;
from 15 to 65 wt. % of b) a toughened epoxy resin comprising
i) core shell rubber particles; and,
ii) at least one cycloaliphatic epoxy resin; and,
from 0.5 to 5 wt. % of c) a photoinitatior, said photoinitator comprising an ionic photoacid generator.

3. The photo-curable composition according to claim 1, wherein said nanosilica particles have an average particle size of from 1 to 40 nm as measured by dynamic light scattering.

4. The photo-curable composition according to claim 1, wherein said nanosilica particles constitute from 10 to 50 wt. % of part a), based on the total weight of said dispersion.

5. The photo-curable composition according to claim 1, wherein said dispersion of part a) is a colloidal silica sol.

6. The photo-curable composition according to claim 1, wherein said epoxy resin of part a) is comprised of at least one diepoxide compound having an epoxy equivalent weight of less than 500.

7. The photo-curable composition according to claim 1, wherein said epoxy resin of part a) is comprised of at least one polyepoxide compound selected from the group consisting of: glycidyl ethers of polyhydric alcohols; gycidyl ethers of polyhydric phenols; and glycidyl esters of polycarboxylic acids.

8. The photo-curable composition according to claim 1, wherein said core shell rubber particles of part b) have an average particle size (d50) of from 10 nm to 300 nm as measured via dynamic light scattering.

9. The photo-curable composition according to claim 1, wherein said core shell rubber particles constitute from 10 to 50 wt. % of part b), based on the total weight of said dispersion.

10. The photo-curable composition according to claim 1, wherein said at least one cycloaliphatic epoxy resin of part b) is selected from the group consisting of: cyclohexanedimethanol diglycidyl ether; bis(3,4-epoxycyclohexylmethyl) adipate; bis(3 4-epoxy-6-methylcyclohexylmethyl) adipate; bis(2,3-epoxycyclopentyl) ether; 3,4-epoxycyclohexylmethyl; 3,4-epoxycyclohexanecarboxylate; 1,4-cyclohexanedimethanol diglycidyl ether; diglycidyl 1,2-cyclohexanedicarboxylate; and, cycloaliphatic epoxy resins obtained by the hydrogenation of aromatic bisphenol A diglycidyl ether (BADGE) epoxy resins.

11. The photo-curable composition according to claim 1, said composition comprising:
from 40 to 60 wt. % of a) a dispersion of nanosilica particles in epoxy resin, said nanosilica particles having an average particle size (d50) of less than 50 nm, as measured by dynamic light scattering, and said epoxy resin being comprised of at least one polyepoxide compound selected from the group consisting of glycidyl ethers of polyhydric alcohols, glycidyl ethers of polyhydric phenols and glycidyl esters of polycarboxylic acids;
from 40 to 60 wt. % of b) a toughened epoxy resin comprising
iii) core shell rubber particles having an average particle size (d50) of from 10 to 300 nm, as measured via dynamic light scattering; and,
iv) at least one cycloaliphatic epoxy resin selected from the group consisting of: cyclohexanedimethanol diglycidyl ether; bis(3,4-epoxycyclohexylmethyl) adipate; bis(3 4-epoxy-6-methylcyclohexylmethyl) adipate; bis(2,3-epoxycyclopentyl) ether; 3,4-epoxycyclohexylmethyl; 3,4-epoxycyclohexanecarboxylate; 1,4-cyclohexanedimethanol diglycidyl ether; diglycidyl 1,2-cyclohexanedicarboxylate; and, cycloaliphatic epoxy resins obtained by the hydrogenation of aromatic bisphenol A diglycidyl ether (BADGE) epoxy resins; and,
from 0.5 to 5 wt. % of c) a photoinitatior, said photoinitator consisting of an ionic photoacid generator.

12. The photo-curable composition according to claim 1, wherein said ionic photoacid generator is a hexafluoroantimonate salt.

13. A method for forming a three dimensional object, said method comprising:
i) providing a carrier and an optically transparent member having a movable build surface, said carrier and build surface defining a build region there between;
ii) within said build region, applying by 3D printing a first layer of the composition as defined in claim 1;
iii) irradiating said build region through said optically transparent member to at least partially cure that first layer;
iv) applying a subsequent layer of said composition by 3D printing on the at least partially cured layer; and,
v) irradiating said build region through said optically transparent member to at least partially cure that subsequent layer.

14. An iterative method according to claim 13 for forming a three dimensional object, wherein said steps iv) and v) are performed and repeated so as to dispose second, third, fourth and further layers within the build region.
